(19) United States
(12) Patent Application Publication
(10) Pub. No.: US 2019/0161403 A1
(43) Pub. Date: May 30, 2019

(54) BLUE REFLECTIVE GLASS SUBSTRATE AND METHOD FOR MANUFACTURING THE SAME

(71) Applicants: AGC GLASS EUROPE, Louvain-La-Neuve (BE); AGC GLASS COMPANY NORTH AMERICA, Alpharetta, GA (US); AGC Inc., Chiyoda Ku (JP); QUERTECH INGENIERIE, Caen (FR)

(72) Inventors: Benjamine NAVET, Louvain-La-Neuve (BE); Pierre BOULANGER, Couthuin (BE); Denis BUSARDO, Gonneville Sur Mer (FR)

(73) Assignees: AGC GLASS EUROPE, Louvain-La-Neuve (BE); AGC GLASS COMPANY NORTH AMERICA, Alpharetta, GA (US); AGC Inc., Chiyoda Ku (JP); QUERTECH INGENIERIE, Caen (FR)

(21) Appl. No.: 16/092,373

(22) PCT Filed: Mar. 13, 2017
(86) PCT No.: PCT/EP2017/055852

§ 371 Date: Oct. 9, 2018

(30) Foreign Application Priority Data
Apr. 12, 2016 (EP) 16164905.8

(51) Int. Cl. C03C 23/00; C03C 3/097; C03C 3/091; C03C 3/087; C03C 4/02

(52) U.S. Cl. CPC C03C 23/0055; C03C 3/097; C03C 4/02; C03C 3/087; C03C 3/091

(57) ABSTRACT

A method for manufacturing blue reflective glass substrates by ion implantation, the method including ionizing a N₂ source gas so as to form a mixture of single charge and multicharge ions of N, forming a beam of single charge and multicharge ions of N by accelerating with an acceleration voltage A between 15 kV and 35 kV and a dosage D between −9.33×10¹⁵×A/kV+3.87×10¹⁷ ions/cm² and 7.50×10¹⁷ ions/cm². A blue reflective glass substrate including an area treated by ion implantation with a mixture of simple charge and multicharge ions according to the method.

The present invention relates to a blue reflective glass substrate and a method of manufacturing the same. It also relates to the use of a blue reflective glass substrate, particularly as glazing.

For esthetical reasons architects and product designers often require a blue color in reflection for glazed products, such as glazings in general, but in particular also for display applications. Most blue reflective glass substrates are obtained by the deposition of coatings on the glass surface. Such layers and in particular multiple layer stacks, usually deposited by physical vapor deposition. These stacks of multiple layers make use of interference effects in order to obtain a blue color in reflection. However they require multiple layer deposition steps with a high composition and layer thickness control, making it a difficult and thus expensive process. Furthermore such multiple layer stacks, usually deposited by physical vapor deposition, are more sensitive to mechanical and/or chemical attack than the glass itself.

There is therefore a need in the art to provide a method for making a blue reflective glass substrate.

According to one of its aspects, the subject of the present invention is to provide a method for producing a blue reflective glass substrate.

According to another of its aspects, the subject of the present invention is to provide a blue reflective glass substrate.

The invention relates to a method for producing a blue reflective glass substrate comprising the following operations
providing a N₂ source gas,
ionizing the N₂ source gas so as to form a mixture of single charge ions and multicharge ions of N,
accelerating the mixture of single charge ions and multicharge ions of N with an acceleration voltage so as to form a beam of single charge ions and multicharge ions of N, wherein the acceleration voltage A is comprised between 15 kV and 35 kV and the ion dosage D is comprised between −9.33×10¹⁵×A/kV+3.87×10¹⁷ ions/cm² and 7.50×10¹⁷ ions/cm²,
providing a glass substrate,
positioning the glass substrate in the trajectory of the beam of single charge and multicharge ions of N.

The inventors have surprisingly found that the method of the present invention providing an ion beam comprising a mixture of single charge and multicharge ions of N, accelerated with the same acceleration voltage applied to a glass substrate leads to a blue color in reflectance. The increased blueness is expressed by the increasingly negative value of the color coordinate b* in reflectance. Advantageously the color coordinate b* in reflectance is less than or equal to −3, more preferably b* in reflectance is comprised between −20 and −3.

Advantageously the color coordinate b* in reflectance is less than or equal to −3, more preferably b* in reflectance is comprised between −20 and −3, and at the same time color coordinate a* in reflectance is comprised between −3 and 3.

According to the present invention the N₂ source gas is ionized so as to form a mixture of single charge ions and mufti charge ions of N. The beam of accelerated single charge ions and multicharge ions may comprise various amounts of the different N ions. Example currents of the respective ions are shown in Table 1 below (measured in milli Ampere).

TABLE 1
Ions of N

| | |
|---|---|
| N⁺ | 0.55 mA |
| N²⁺ | 0.60 mA |
| N³⁺ | 0.24 mA |

According to the present invention, the key ion implantation parameters are the ion acceleration voltage and the ion dosage.

The positioning of the glass substrate in the trajectory of the beam of single charge and multicharge ions is chosen such that certain amount of ions per surface area or ion dosage is obtained. The ion dosage or dosage is expressed as number of ions per square centimeter. For the purpose of the present invention the ion dosage is the total dosage of single charge ions and multicharge ions. The ion beam preferably provides a continuous stream of single and multicharge ions. The ion dosage is controlled by controlling the exposure time of the substrate to the ion beam. According to the present invention multicharge ions are ions carrying more than one positive charge. Single charge ions are ions carrying a single positive charge.

In one embodiment of the invention the positioning comprises moving glass substrate and ion implantation beam relative to each other so as to progressively treat a certain surface area of the glass substrate. Preferably they are moved relative to each other at a speed comprised between 0.1 mm/s and 1000 mm/s. The speed of the movement of the glass relative to the ion implantation beam is chosen in an appropriate way to control the residence time of the sample in the beam which influences ion dosage of the area being treated.

The method of the present invention can be easily scaled up so as to treat large substrates of more than 1 m², for example by continuously scanning the substrate surface with an ion beam of the present invention or for example by forming an array of multiple ion sources that treat a moving substrate over its whole width in a single pass or in multiple passes.

According to the present invention the acceleration voltage and ion dosage are preferably comprised in the following ranges:

TABLE 2

| parameter | general range | preferred range |
|---|---|---|
| Acceleration voltage | 15 to 35 | 32 to 35 |
| A [kV] | | |
| Ion dosage D | −9.33 × 10¹⁵ × A/kV + 3.87 × | 6 × 10¹⁷ to 7 × 10¹⁷ |
| [ions/cm²] | 10¹⁷ | |
| | to 7.50 × 10¹⁷ | |

The inventors have found that ion sources providing an ion beam comprising a mixture of single charge and multicharge ions, accelerated with the same acceleration voltage are particularly useful as they may provide lower dosages of multicharge ions than of single charge ions. It appears that a glass substrate having a having a blue reflectance color may be obtained with the mixture of single charge ions, having higher dosage and lower implantation energy, and multicharge ions, having lower dosage and higher implantation energy, provided in such a beam. The implantation energy, expressed in Electron Volt (eV) is calculated by multiplying the charge of the single charge ion or multicharge ion with the acceleration voltage.

In a preferred embodiment of the present invention the temperature of the area of the glass substrate being treated, situated under the area being treated is less than or equal to the glass transition temperature of the glass substrate. This temperature is for example influenced by the ion current of the beam, by the residence time of the treated area in the beam and by any cooling means of the substrate.

In one embodiment of the invention several ion implantation beams are used simultaneously or consecutively to treat the glass substrate.

In one embodiment of the invention the total dosage of ions per surface unit of an area of the glass substrate is obtained by a single treatment by an ion implantation beam.

In another embodiment of the invention the total dosage of ions per surface unit of an area of the glass substrate is obtained by several consecutive treatments by one or more ion implantation beams.

In a preferred embodiment the glass substrate is treated on both of its faces with the method according to the present invention so as to maximize the blue reflectance effect.

The method of the present invention is preferably performed in a vacuum chamber at a pressure comprised between 10⁻² mbar and 10⁻⁷ mbar, more preferably at between 10⁻⁵ mbar and 10⁻⁶ mbar.

An example ion source for carrying out the method of the present invention is the Hardion+ RCE ion source from Quertech Ingénierie S.A.

The color in reflection is expressed using CIELAB values a* and b* under illuminant D65 using 10° observer angle and is measured on the side of the substrate treated with the method of the present invention. CIE L*a*b* or CIELAB is a color space specified by the International Commission on Illumination.

The present invention also concerns the use of a mixture of single charge and multicharge ions of N to increase the blue color of the reflectance, the mixture of single charge and multicharge ions being implanted in the glass substrate with an ion dosage and acceleration voltage effective to increase the blue color of the reflectance of the glass substrate.

Increasing the blue color of the reflectance of a glass substrate is equivalent to shifting the color coordinate b* of the reflectance of a glass substrate to more negative values.

The color coordinate b* of an untreated clear glass substrate is generally comprised between −1 and 1. Advantageously the mixture of single and multicharge ions of N is used to increase the blue color of the reflectance of a glass substrate, the mixture of single charge and multicharge ions being implanted in the glass substrate with a dosage and acceleration voltage effective to increase the reflectance in the blue color in reflectance of the glass substrate to b* in reflectance less than or equal to −3, preferably to b* in reflectance comprised between −20 and −3.

Advantageously the mixture of single and multicharge ions of N is used to increase the blue color of the reflectance of a glass substrate, the mixture of single charge and multicharge ions being implanted in the glass substrate with a dosage and acceleration voltage effective to increase the reflectance in the blue color in reflectance of the glass substrate to b* in reflectance less than or equal to −3, preferably to b* in reflectance comprised between −20 and −3, while maintaining the color coordinate a* in reflectance comprised between −3 and 3.

According to the present invention, the mixture of single charge and multicharge ions of N preferably comprises N⁺, N²⁺ and N³⁺.

According to another preferred embodiment of the present invention the mixture of single charge and multicharge ions of N comprises a lesser amount of N³⁺ than of N⁺ and N²⁺ each. In a more preferred embodiment of the present invention, the mixture of single charge and multicharge ions of N comprises 40-70% of N⁺, 20-40% of N²⁺, and 2-20% of N³⁺.

According to the present invention the acceleration voltage and ion dosage effective to increase the blue color of the reflectance of the glass substrate is preferably comprised in the following ranges:

TABLE 3

| parameter | general range | preferred range |
|---|---|---|
| Acceleration | 15 to 35 | 32 to 35 |
| voltage [kV] | | |
| Ion dosage | −9.33 × 10¹⁵ × A/kV + 3.87 × | 6 × 10¹⁷ to 7 × 10¹⁷ |
| [ions/cm²] | 10¹⁷ | |
| | to 7.50 × 10¹⁷ | |

The present invention also concerns a blue reflective, ion implanted glass substrate having an increased reflectance in the blue color wherein a mixture of single charge and multicharge ions of N has been implanted according to the method of the present invention.

Advantageously color coordinate b* in reflectance of the blue reflective, ion implanted glass substrates of the present invention is less than or equal to −3, preferably b* in reflectance is comprised between −20 and −3.

Advantageously color coordinate a* in reflectance of the ion implanted glass substrates of the present invention is comprised between −3 and 3. At the same time the color coordinate b* in reflectance of the glass substrate is preferably less than or equal to −3, more preferably b* in reflectance is comprised between −20 and −3.

Advantageously the implantation depth of the ions may be comprised between 0.1 μm and 1 μm, preferably between 0.1 μm and 0.5 μm.

The glass substrate used in the present invention is usually a sheet like glass substrate having two opposing major surfaces. The ion implantation of the present invention may be performed on one or both of these surfaces. The ion implantation of the present invention may be performed on part of a surface or on the complete surface of the glass substrate.

In another embodiment, the present invention also concerns glazings incorporating blue reflective glass substrates of the present invention, no matter whether they are monolithic, laminated or multiple with interposed gas layers. In such embodiment, the substrate may be tinted, tempered, reinforced, bent, folded or ultraviolet filtering.

These glazings can be used both as internal and external building glazings, and as protective glass for objects such as panels, display windows, glass furniture such as a counter, a refrigerated display case, etc., also as automotive glazings such as laminated windshields, mirrors, antiglare screens for computers, displays and decorative glass.

The glazing incorporating the blue reflective glass substrate according to the invention may have interesting additional properties. Thus, it can be a glazing having a security function, such as the laminated glazings. It can also be a glazing having a burglar proof, sound proofing, fire protection or anti-bacterial function.

The glazing can also be chosen in such a way that the substrate treated on one of its faces with the method according to the present invention, comprises a layer stack deposited on the other of its faces. The stack of layers may have a specific function, e.g., sun-shielding or heat-absorbing, or also having an anti-ultraviolet, antistatic (such as slightly conductive, doped metallic oxide layer) and low-emissive, such as silver-based layers of the or doped tin oxide layers. It can also be a layer having anti-soiling properties such as a very fine TiO₂ layer, or a hydrophobic organic layer with a water-repellent function or hydrophilic layer with an anti-condensation function.

The layer stack can be a silver comprising coating having a mirror function and all configurations are possible. Thus, in the case of a monolithic glazing with a mirror function, it is of interest to position a blue reflective glass substrate of the present invention with the treated face as face 1 (i.e., on the side where the spectator is positioned) and the silver coating on face 2 (i.e., on the side where the mirror is attached to a wall), thus the perception of the blue color in reflectance by the spectator is ensured.

In the case of a double glazing (where according to convention the faces of glass substrates are numbered starting with the outermost face), it is thus possible to use the antireflective treated face as face 1 and the other functional layers on face 2 for anti-ultraviolet or sun-shielding and 3 for low-emissive layers. In a double glazing, it is thus possible to have at least one blue reflective face as on one of the faces of the substrates and at least one layer or a stack of layers providing a supplementary functionality. The double glazing can also have several blue reflective faces, particularly at least as faces 1 and 4. For a monolithic glazing 1 it is possible to deposit an antistatic function layer on the side opposite the blue reflective face.

The substrate may also undergo a surface treatment, particularly acid etching (frosting), the ion implantation treatment may be performed on the etched face or on the opposite face.

The substrate, or one of those with which it is associated, can also be of the printed, decorative glass type or can be screen process printed.

A particularly interesting glazing incorporating the antireflective glass substrate according to the invention is a glazing having a laminated structure with two glass substrates, comprising a polymer type assembly sheet between a blue reflective glass substrate of the present invention, with the ion implantation treated surface facing away from the polymer assembly sheet, and another glass substrate. The polymer assembly sheet can be from polyvinylbutyral (PVB) type, polyvinyl acetate (EVA) type or polycyclohexane (COP) type.

This configuration, particularly with two heat treated, that is bent and/or tempered, substrates, makes it possible to obtain a car glazing and in particular a windshield of a very advantageous nature as the blue reflective color is difficult to achieve by other means.

The glass substrate according to this invention may be a glass sheet of any thickness having the following composition ranges expressed as weight percentage of the total weight of the glass.

| | |
|---|---|
| SiO₂ | 35-85%, |
| Al₂O₃ | 0-30%, |
| P₂O₅ | 0-20% |
| B2O₃ | 0-20%, |
| Na₂O | 0-25%, |
| CaO | 0-20%, |
| MgO | 0-20%, |
| K₂O | 0-20%, and |
| BaO | 0-20%. |

The glass substrate according to this invention is preferably a glass sheet chosen among a soda-lime glass sheet, a borosilicate glass sheet, or an aluminosilicate glass sheet. In a particularly preferred embodiment the glass sheet is a clear glass sheet.

The glass substrate according to this invention preferably bears no coating on the side being subjected to ion implantation.

The glass substrate according to the present invention may be a large glass sheet that will be cut to its final dimension after the ion implantation treatment or it may be a glass sheet already cut to its final size.

Advantageously the glass substrate of the present invention may be a float glass substrate. The ion implantation method of the present invention may be performed on the air side of a float glass substrate and/or the tin side of a float glass substrate. Preferably the ion implantation method of the present invention is performed on the air side of a float glass substrate.

In an embodiment of the present invention the glass substrate may be a chemically strengthened glass substrate.

The optical properties were measured using a Hunterlab Ultrascan Pro Spectrophotometer.

### DETAILED DESCRIPTION OF PARTICULAR EMBODIMENTS

The ion implantation examples were prepared according to the various parameters detailed in the tables below using an RCE ion source for generating a beam of single charge and multicharge ions. The ion source used was a Hardion+ RCE ion source from Quertech Ingénierie S.A.

All samples had a size of 10×10 cm² and were treated on the entire surface by displacing the glass substrate through the ion beam at a speed between 20 and 30 mm/s.

The temperature of the area of the glass substrate being treated was kept at a temperature less than or equal to the glass transition temperature of the glass substrate.

For all examples the implantation was performed in a vacuum chamber at a pressure of 10⁻⁶ mbar.

Ions of N were implanted in 4 mm regular clear soda-lime glass substrates. The parameters can be found the table 4 below.

TABLE 4

| | | | acceler- | | a* | b* |
|---|---|---|---|---|---|---|
| | | | ation | | reflectance | reflectance |
| refer- | Source | glass | voltage | ion dosage | [CIELAB, | [CIELAB, |
| ence | gas | substrate | [kV] | [ions/cm²] | D65, 10°] | D65, 10°] |
| E1 | N₂ | Sodalime | 35 | 1 × 10¹⁷ | −1.12 | −5.16 |
| E2 | N₂ | Sodalime | 25 | 2.5 × 10¹⁷ | −0.93 | −4.84 |
| E3 | N₂ | Sodalime | 15 | 7.5 × 10¹⁷ | −1.95 | −5.04 |
| E4 | N₂ | Sodalime | 25 | 7.5 × 10¹⁷ | −4.07 | −8.18 |
| C1 | | Sodalime | 0 | 0 | −0.53 | −0.56 |
| C2 | N2 | Sodalime | 20 | 6 × 10¹⁶ | −0.22 | 0.40 |
| C3 | N2 | Sodalime | 25 | 6 × 10¹⁶ | −0.14 | −0.57 |

As can be seen from examples E1 to E4 of the present invention, the chosen key parameters used for the ion implantation, where acceleration voltage A is comprised between 15 kV and 35 kV and the dosage D is comprised between −9.33×10¹⁵×A/kV+3.87×10¹⁷ ions/cm² and 7.50×10¹⁷ ions/cm², leads to an increased blue color of the reflectance of the glass substrate with b* being less than −3. An untreated sodalime glass sample C1 as well as other sodalime glass samples C2 and C3, treated with implantation parameters outside of the specific ranges of the present invention, do not provide the sought after blue color in reflectance.

1. A method for producing a blue reflective glass substrate, the method comprising:
a) providing a N₂ source gas,
b) ionizing the N₂ source gas so as to form a mixture of single charge ions and multicharge ions of N,
c) accelerating the mixture of single charge ions and multicharge ions with an acceleration voltage so as to form a beam of single charge ions and multicharge ions of N, wherein the acceleration voltage A is comprised between 15 kV and 35 kV and the dosage D is comprised between −9.33×10¹⁵×A/kV+3.87×10¹⁷ ions/cm² and 7.50×10¹⁷ ions/cm²,
d) providing a glass substrate, and
e) positioning the glass substrate in the trajectory of the beam of single charge and multicharge ions of N.

2. The method for producing a blue reflective glass substrate according to claim 1, wherein the acceleration voltage A is comprised between 32 kV and 35 kV and the dosage D is comprised between 6×10¹⁷ ions/cm² and 7×10¹⁷ ions/cm².

3. The method for producing a blue reflective glass substrate according to claim 1 wherein the glass substrate comprises the following composition ranges expressed as weight percentage of the total weight of the glass:
SiO₂ 35-85%,
Al₂O₃ 0-30%,
P₂O₅ 0-20%,
B₂O₃ 0-20%,
Na₂O 0-25%,
CaO 0-20%,
MgO 0-20%,
K₂O 0-20%, and
BaO 0-20%.

4. The method for producing a blue reflective glass substrate according to claim 3, wherein the glass substrate is selected from the group consisting of a soda-lime glass sheet, a borosilicate glass sheet and an aluminosilicate glass sheet.

5. The method for producing a blue reflective glass substrate according to claim 4, wherein the glass substrate is a clear glass sheet.

6. A method, comprising employing a mixture of single charge and multicharge ions of N to increase the blue color of the reflectance of a glass substrate, the mixture of single charge and multicharge ions being implanted in the glass substrate with an ion dosage and acceleration voltage effective to increase the blue color of the reflectance of the glass substrate.

7. The method according to claim 6, the mixture of single charge and multicharge ions being implanted in the glass substrate with a dosage and acceleration voltage effective to increase the blue color of the reflectance to b* in reflectance to less than or equal to −3.

8. The method according to claim 7, the mixture of single charge and multicharge ions being implanted in the glass substrate with a dosage and acceleration voltage effective to increase the blue color of the reflectance to b* in reflectance to less than or equal to −3 while maintaining the color coordinate a* in reflectance comprised between −3 and 3.

9. The method according to claim 8, the mixture of single charge and multicharge ions being implanted in the glass substrate with an acceleration voltage A comprised between 15 kV and 35 kV and the dosage D is comprised between −9.33×10¹⁵×A/kV+3.87×10¹⁷ ions/cm² and 7.50×10¹⁷ ions/cm².

10. A blue reflective glass substrate produced by the method of claim 1.

11. A monolithic glazing, laminated glazing or multiple glazing with interposed gas layer, comprising a blue reflective glass substrate according to claim 10.

12. The glazing of claim 10, further comprising sun-shielding, heat-absorbing, anti-ultraviolet, antistatic, low-emissive, heating, anti-soiling, security, burglar proof, sound proofing, fire protection, anti-mist, water-repellant, anti-bacterial or mirror means.

13. The glazing of claim 11, wherein said antireflective glass substrate is frosted, printed or screen process printed.

14. The glazing of claim 11, wherein said substrate is tinted, tempered, reinforced, bent, folded or ultraviolet filtering.

15. The glazing of claim 11, comprising a laminated structure comprising a polymer type assembly sheet interposed between the antireflective glass substrate, with the ion implantation treated surface facing away from the polymer assembly sheet, and another glass substrate.

16. The glazing of claim 15, wherein said glazing is a car windshield.
